(19) United States
(12) Patent Application Publication
(10) Pub. No.: US 2007/0178191 A1
(43) Pub. Date: Aug. 2, 2007

(54) Wine produced using tender coconut and product

(76) Inventor: Sebastian P. Augustine, Kerala (IN)

Correspondence Address: MATHEW R. P. PERRONE, JR., 210 SOUTH MAIN STREET, ALGONGUIN, IL, 60102-2639, US

(21) Appl. No.: 11/570,144

(22) PCT Filed: Sep. 5, 2005
(86) PCT No.: PCT/IN05/00297

§ 371 Date: Dec. 7, 2006

(30) Foreign Application Priority Data
Sep. 8, 2004 (IN) 900/CHE/2004

(51) Int. Cl. C12G 1/00

(52) U.S. Cl. 426/15

(57) ABSTRACT

The invention is related to the production of wine from tender coconut named tender coconut wine. The ingredients are Tender coconut water or tender coconut water and its soft kernel mix collected from farm fresh tender coconuts of seven months ripe or less, sugar, cinnamon, clove, dry vanilla, fruit juice etc. Pathimukam (cesalpina sappan), a natural colouring agent, is added for color during fermentation process. Tender coconut wines need a fermentation period of 10-28 days. The clarification is done with egg white after fermentation. For optional fortification, cashew apple alcohol or any such alcohol is added. As garden fresh tender coconuts are devoid of wild yeast and bacteria, wine made of it, will be automatically pure and natural. The wine is a highly healthy, hygienic and nutritional beverage.

The present invention is related to the production of wine and more particularly to production of wine through fermentation of tender coconut water from coconuts aged less than eight months.

### BACKGROUND OF THE INVENTION

Tender coconut water is widely known for its nutritional and medicinal properties. It is considered nature's finest health drink. It is now heavily sought after as a health drink for sports persons as well. The demand for natural drinks is increasing globally. Tender coconut water is the only wholesome beverage that nature has provided to the humanity. It improves antibodies and immunity and is recommended for several diseases in Ayurvedic and Allopathic systems. It is rich in vitamins, minerals and proteins. Natural contents in tender coconut water include Potassium, Sodium, Calcium, Phosphorus, Iron, Magnesium, Copper, Glucose, Fructose, Sucrose etc., in a balanced combination.

The existing wine production methods in coconut family use ripened coconuts (aged more than 10 months). Coconut water, unlike tender coconut water, is a waste product of coconut industry and is not widely used for soft drinks or sports drinks. The previous methods mentioned in CN1072452A, CN1126757A and DE4220403 A1 are describing the production of wine from ripened coconut water and coconut pulp or grinded coconut, sugar, honey, milk powder and natural water as main ingredients and using some chemicals for wine making. The color of the wines in the above methods is white or lightly yellowish—more toward white and not red in color. The tender coconut wines are produced in red, white, and yellow in color depending up on the verity of tender coconut and variation of ingredients.

The existing coconut wine recipe with No DE 4220403A1 discloses the production of coconut wine with a mixture of 30 grams yeast, 1 liter water and 1 kilogram sugar is prepared and fermented for one day. About 1200 grams ground coconut kernel is soaked in 8 liters of water. After two hours the mash is minced by a mixture and the yeast sugar mixture is added. Then a complicated fermentation of cooling and heating Process for fermentation follows until the wine results after 10 days.

The existing application No. 92112635.2-CN 1072452A discloses the production of coconut wine from coconut water and coconut pulp collected from ripened coconut only. The method of this invention is as follows: the yeast mash is prepared by a coconut pulp and juice adding milk powder at the weight ratio of 1-0.1-0.5.

The existing application No. 95100129.9-CN 1126757A discloses the production of coconut wine from coconut water and coconut pulp collected from ripened coconut only. The method of the above invention is as follows, first the cultivation and breaking of wine yeast and yeast mash is prepaid with ripened coconut water milk powder, and 2% of hydrochloric acid.

The yeast mash is put in a fermenting jar; followed by addition of processed odorless alcohol of 50-60 and 45-55% sugar syrup. The yeast wine of 3-5% fermentation is added slowly while stirring; then continuing to stir for 30 minutes for fermentation. After 8-10 days, straining is accomplished with a 120 fine strainer, after this a secondary fermentation for some days more.

### SUMMARY OF THE INVENTION

Among the many objectives of the present invention is the provision of a tender coconut wine made from fermentation of tender coconut water from coconuts aged less than eight months.

Another objective of the present invention is the provision of dry wines using tender coconut water.

Also, an objective of the present invention is the provision of dry wines using tender coconut water.

Moreover, an objective of the present invention is the provision of red wines using tender coconut water.

Another objective of the present invention is the provision of white wines using tender coconut water.

These and other objectives of the invention (which other objectives become clear by consideration of the specification, claims and graphs as a whole) are met by providing a tender coconut wine from tender coconuts aged seven months ripe, with a variety of additives.

### DESCRIPTION OF THE PREFERRED EMBODIMENTS

The present invention is related to the production of wine; through fermentation of tender coconut water from tender coconuts ripened up to seven months and collected fresh, named Tender Coconut Wine, both sweet and dry.

They are:

Dry wines and sweet wines—

Using tender coconut water.

Using tender coconut water and its kernel mix.

Using tender coconut water, its kernel mix and fruit pulp.

Red wine, dry and sweet, using tender coconut water and crushed black grape pulp Light wine, medium wine, strong wine, made by using tender coconut water.

The present invention is based on the production of tender coconut wine from tender coconuts aged seven months ripe and below (the primary product of coconut trees); does not use natural water. It is widely used for sports drink, soft drink and a medicinal valued product in Ayurvedic and Allopathic systems and used for injection with glucose saline to gastroenteritis patients. Tender coconut water is medicinal and used as nutrient supplement and sports drink as tender coconut water is scientifically proved to be of medicinal properties and recommended by the World Health Organization as a natural sports drink.

The main object of this invention is that natural water is eliminated at any stage of processing and tender coconut water is substituted for the same. The mother culture is prepared in a simple method with tender coconut water, sugar and dry wine yeast within a short period and no other ingredients like milk powder and the like are added.

At a time when people prefer organic products to artificial beverages, demand for natural products is increasing worldwide. This method has been developed by the inventor to produce wine from tender coconut water or tender coconut water and its soft kernel mix without using artificial ingredients at any stage of the process, thus keeping the end product entirely pure and natural. In this process tender coconut water replaces natural water in the preparation of a variety of wines with light, medium, and strong alcohol contents. A tender coconut is very different from a coconut in type, quality, taste, aroma and contents. Ripened coconut is a food and oil-based nut. While tender coconut water, though available in abundance, is extremely difficult to preserve and is prohibitively expensive and hard to store.

Quality Attributes of Tender Coconut Water

| Characteristics Measure | Tender Coconut Water |
|---|---|
| Total Solids (%) | Up to 7.1 |
| Reducing sugars (%) | Up to 4.4 |
| Minerals (%) | Up to 0.6 |
| Protein (%) | Up to 0.01 |
| Fat (%) | Up to 0.01 |
| Acidity mg (%) | Up to 120.0 |
| PH | Up to 4.5 |
| Potassium (mg/100 g) | Up to 290 |
| Sodium (mg/100 g) | Up to 42 |
| Calcium (mg/100 g) | Up to 44 |
| Magnesium (mg/100 g) | Up to 10 |
| Phosphorus (mg/100 g) | Up to 9.2 |
| Iron (mg/100 g) | Up to 106 |
| Copper (mg/100 g) | Up to 26 |

Wine making is still an area to be explored. For ages wine has been made from fresh fruits or berries with natural water and sugar. Sometimes wine is also made from coconut meat with coconut water or coconut milk. The common way of preparation of wine needs to add chemicals like potassium Meta bisulphite (KMS) or camp den tablets and so forth to prevent contamination by wild yeast and bacteria. It was the aim of the inventor to formulate a method to produce wine using the abundantly available tender coconut water and other farm products alone.

The wine made from tender coconut is free from any chemicals or sulphur dioxide. This can be developed as an organic product. At a time when people prefer organic products to artificial beverages, demand for natural products is increasing worldwide. Large-scale production of wine using tender coconut would be helpful to the coconut farmers who are suffering huge losses due to incidence of eriophyd mite and uncertain markets.

Ayurvedic literature refers to the medicinal value of tender coconut water. However, a study of recent times reported from India attracts special attention. The study was conducted by Bio Chemistry Department of Trivandrum Medical College, Kerala in 1968 to assess the efficiency of the tender coconut water when administered intravenously in gastroenteritis patients in comparison to glucose saline. Tender coconut water was injected to 16 patients in Medical College Hospital while 20 patients were injected with glucose saline. The study found that the amount of potassium was higher in patients injected with tender coconut water on examination after 24 hours.

The results of various studies conducted in other countries also underline the medicinal effect of tender coconut water. For instance some urologists in the Philippines have proved that the utilization of tender coconut water orally or intravenously is effective in treating urethral disorders and in reducing or dissolving all kinds of kidney stones. Dr. Mecolalag treated 204 patients with kidney stones using tender coconut water and only 16 patients had to undergo surgical removal of the stone (Milla and Bocetta in 1990).

Medicinal Properties of Tender Coconut Water

Good for feeding infants suffering from intestinal disturbances.

Oral dehydration medium.

Contains organic compounds possessing growth promoting properties.

Keeps the body cool.

Application on the body prevents prickly heat and summer boils and reduces the rashes caused by small pox, chicken pox, measles and the like.

Kills intestinal worms.

Presence of saline and albumen makes it a good drink in cholera cases.

Checks urinary infections.

Excellent tonic for the old and the sick.

Cures malnourishment.

Diuretic.

Effective in treatment of kidney and urethral stones.

Can be injected intravenously in emergency cases.

Found as blood plasma substitute because it is sterile, does not produce heat, does not destroy red blood cells and is readily accepted by the body.

Aids the quick absorption of the drugs and makes their peak concentration in the blood easier by its electrolytic effect.

Urinary antiseptic and eliminates poisons in case of mineral poisoning.

This method has been developed for producing Tender Coconut Wine using tender coconut by fermentation process without using artificial ingredients at any stages of the process, thus keeping the product pure and natural.

The processes involved in the preparation are

Preparation of mother culture (starter mix)

preparation of must

Fermentation

Clarification

Fortification and Ageing

4. Firstly, a culture of yeast is multiplied prior to the preparation; the multiplied culture yeast is called mother culture or starter mix.

5. The preparation of starter mix is as follows:

About 20 to fifty grams of sugar and 0.5 to 5.0 grams of dry wine yeast is added to 200 ML freshly collected tender coconut water and stirred to dissolve. The jar is then closed tightly and kept for more than 1 hour (depending on climatic conditions). The yeast multiplies rapidly. After multiplication the starter mix is ready to use.

6. Preparation of Must.

Preparation of must differs for each type of wine as described in the Example.

Fermentation

The must collected in the jar is kept in a controlled temperature below 29° C. (away from direct sunlight) for 10-28 days or more for fermentation. It needs to be stirred once or twice in the initial stage. Once the fermentation is complete and the must becomes wine, it is filtered and collected in jars. In red wine making, fermentation is continued by letting the grape skins (which do have color) stay in contact with the must for the right amount of time.

Clarification

During the maturing process, there is natural clarification of wine with egg white. Two egg whites (beaten) are added to the wine to bring about the clarification process after fermentation. The wine added with egg white should be kept for about 15 days for clarification without moving or stirring. The clear wine can be filtered and collected in bottles or jars.

Optional Fortifacation and Aging

Fortification is optional. A necessary quantity of odorless alcohol (cashew apple alcohol or any suitable alcohol) is added to the wine to make it strong. After pasteurization, keep this wine in a secluded place (preferably under ground) up to 12 months or more for better quality. In the aging process the wine loses its raw and harsh flavor and mellows down considerably acquiring a smooth flavor and characteristic bouquet and aroma. Now the Tender coconut wine is ready to use

Preperation of Must

### EXAMPLE

The methods for producing Tender coconut wines and the ingredients are explained below.

(a) Tender coconut water is derived from freshly collected tender coconuts seven months ripe or below or tender coconut water and its soft kernel mix of above age nuts—3.8 L in a jar; (b) sugar—1.00 kg to 2 kg (c) dry vanilla beans 5-10 in number (without extracting); (d) Fruit pulp of any farm fresh fruit like mango, pineapple, passion fruit, grape, lemon, and jack fruit and the like or any mixed fruit pulp for color, taste, aroma and control of PH. Fruits are preferably cleaned with pure water after removing the damaged, wild yeast and bacteria affected ones. Mixing of items (b) and (d) in tender coconut water or tender water and its kernel mix, occurs in the jar. The mother culture prepared as in step 5 is added to the must and stirred well. The jar is then closed to allow for fermentation, and clarification, fortification, pasteurization, and aging as above to make tender coconut wine. The wine is white or slightly yellow Brown or red in color depending on the verity of Fruits and Tender Coconut and variation in quantity of fruit pulp. (b) Alternatively, tender coconut water is collected from freshly collected tender coconuts seven months ripe or below. About 1.8 L is placed in ajar; (b) to this is added crushed farm-fresh black grape pulp with skin and seeds—2 L (grapes are preferably cleaned with pure water after removing the damaged, wild yeast and bacteria affected grapes and dried with clean dry cloths); (c) sugar 1.00 kg to 2 kg; (d) dry vanilla beans 5-10 No's; (e) chocked pathimukham (Cesalpina sappan) n10-20.g as coloring agent. Then items (b) to (e) are mixed in the tender coconut water in the jar add mother culture prepared as in step 5 (page No. 5) for producing tender coconut wine (red wine) with the above process.

Wherein the level of sugar content is increased or decreased to make sweet or dry varieties of tender coconut wine and to adjust its alcohol content. The quantity of Pathimukham (Cesalpina sappan) is increased or decreased for the variation in color of the wine

The following ingredients, chocked cinnamon 2-4 G., chocked clove 10-20 in number; can be added directly (without extracting) to the above must with the other ingredients for variation in flavor and aroma. The quantity of sugar may be varied due to the variety and maturity of tender coconut and fruits, and the condition of soil and climate of farms.

When all the above ingredients are collected from organically certified farms, the tender coconut wines come under the category of organic.

The tender coconut wine produced with tender coconut water is cost-effective and eco friendly as 75% of the raw materials are converted into the finished products and leave out minimal residue.

There are no specifications for Tender coconut wine. The only specification available now relate to wine produced from grapes and the like. A comparison of the test report of tender coconut wine with the Bureau of Indian Standard specification for grape wines:

| TEST | | | | |
|---|---|---|---|---|
| Tender coconut sweet | | | | |
| White wine | | RESULT | BIS SPECIFICATION | |
| 1. | Ethyl alcohol % by vol | 12.25% | 10.5% to 15% | |
| 2. | Total acidity as tartaric | 4.98 g | 4 to 15 | g |
| | acid g/liter max | | | |
| 3. | Volatile acidity | 0.19 g | 1.3 | g |
| | expressed as acetic acid | | | |
| | g/liter max | | | |
| 4. | Sulphur dioxide | NIL | 350 | mg |
| | Mg/liter max | | | |
| 5. | Free sulphur dioxide | NIL | NIL | |
| | Mg/liter max | | | |
| 6. | Copper mg/liter max | 0.15 mg | 5 | mg |
| 7. | Iron mg/liter max | 0.81 mg | 15 | mg |
| 8. | Reducing residual sugar | — | 150 | g max |
| | g/liter max | | | |
| 9. | Sucrose g/liter max | — | 150 | g max |

| | | |
|---|---|---|
| | Total sugars, % by wt. | 17.46% |
| 10. | Presence of methyl | Negative |
| | alcohol | |
| 11. | Total dry extract % by | 25.48% |
| | volume | |

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art.

Such modifications are clearly covered by this disclosure.

What is claimed and sought to be protected by Letters Patent is:

1. Tender coconut wine made through fermentation of tender coconut water from tender coconuts up to seven months old Whereas wine is traditionally made from a variety of fruits fermented in water and sometimes from coconuts in coconut water, the present invention is characterized by a single stage of fermentation of seven-month-old tender coconut water comprising preparation of mother culture by mixing tender coconut water, sugar and yeast and keeping it for multiplication for more than half an hour; preparation of must by mixing the prepared mother culture to tender coconut water and sugar as main ingredients; fermentation in controlled temperature for 10-28 days; clarification with egg white for a fortnight; pasteurization of wine and the bottles in which it is to be stored; and ageing Up to a year.

2. A product as claimed in claim 1, wherein the level of sugar content is increased or decreased to make sweet or dry varieties of tender coconut wine and to adjust its alcohol content, depending on the variety and maturity of tender coconuts and climatic conditions and nature of soil of the farm.

3. A product as claimed in claims 1 & 2, wherein spices grown on the foothills of the Western Ghats in Kerala—cinnamon, clove, vanilla, and pathimukham (Cesalpina sappan)—are added directly (without extracting essence) to the must for the production of tender coconut wine.

4. A product as claimed in claimed 1 & 2, wherein fresh fruits such as grape, mango, pineapple, passion fruit lime etc. are used to make tender coconut wines that vary in acidity, taste and colour.

5. Products made as in claims 1-4 are medicinal and used as nutrient supplement and sports drink as tender coconut water is scientifically proved to be of medicinal properties and recommended by the World Health Organization as a natural sports drink.

6. Products made as in claims 1-4 are organic when the ingredients are freshly collected from certified organic farms.

7. Products made as in claims 1-4 are cost-effective and eco-friendly as 75% of the raw materials are converted into the finished products and leave out minimal residue.

8. Products made as in claims 1-4 have a long shelf life while tender coconut water though available in abundance is extremely difficult to preserve, if at all possible it is prohibitively expensive and hard to store.
